(19) United States
(12) Patent Application Publication
(10) Pub. No.: US 2026/0126932 A1
(43) Pub. Date: May 7, 2026

(54) A Deep Neural Network Oriented Memory Access Management Method for Heterogeneous Multi-core Systems

(71) Applicant: Beijing University of Technology, Beijing (CN)

(72) Inventors: Juan Fang, Beijing (CN); Yuening Wang, Beijing (CN); Ran Zhai, Beijing (CN)

(21) Appl. No.: 19/159,990

(22) PCT Filed: Dec. 20, 2023
(86) PCT No.: PCT/CN2023/140148

§ 371 Date: Jan. 21, 2026

(30) Foreign Application Priority Data
Nov. 9, 2023 (CN) 202311487081.8

(51) Int. Cl. G06F 3/06; G06N 3/08

(52) U.S. Cl. CPC G06F 3/0655; G06F 3/0604; G06F 3/0673; G06N 3/08

(57) ABSTRACT

The invention discloses a memory access management method for a heterogeneous multi-core system oriented to a deep neural network, belonging to the storage system structure field of a computer system. The invention utilizes CPU-GPU heterogeneous multi-core system to accelerate DNN model training, and designs a memory access controller according to its memory access characteristics. In the DNN training process, the final cache shared by multiple cores is unloaded, preretrieved and released, and the fine-grained data transmission process significantly improves the utilization rate of the final cache. In addition, the memory access controller also designed a delay hiding mechanism, by overlapping the access process of a large number of intermediate data in the feature extraction layer and the calculation process, reducing the calculation performance loss caused by the miss of the final level cache and the need to wait for the memory access response of DRAM during the model calculation process, and optimizing the training efficiency.

### TECHNICAL FIELD

The invention belongs to the field of computer system storage system structure, and specifically relates to a storage structure based on a heterogeneous multi-core system, a cache offloading and prefetching method deployed for the training process of a deep neural network model.

### BACKGROUND

Deep neural networks (DNN) have been widely used in various fields such as computer vision, speech recognition, and natural language processing due to their excellent performance. The proliferation of deep learning uses has led to the emergence of more and more software frameworks that analyze and facilitate neural networks. As developers continue to add more features and improve computational efficiency, the list of available frameworks continues to expand. Since GPUs can significantly accelerate the highly parallel DNN training process, these frameworks provide powerful backend support for GPU software libraries such as cuDNN. Today, nearly every group involved in training neural networks is deploying GPUs to accelerate deep learning.

A common limitation of currently popular machine learning frameworks is that the memory capacity of the GPU in the system ultimately limits the size of the DNN that can be trained. The DNN model trained by the stochastic gradient descent algorithm is designed as a multi-layer structured neural network. The training of these neural networks involves a series of layer-by-layer calculations, the order of which is statically fixed, and goes through millions to tens of millions during the entire training process. One billion iterations. Due to the strong data dependence of the hierarchical calculation of the stochastic gradient descent algorithm, the GPU can only process a single layer of calculations at the same time during training. In order to adapt this computing characteristic, currently popular machine learning frameworks generally adopt a network-wide memory allocation strategy, allowing the GPU memory to back up the intermediate feature maps of all layers in the network for gradient updates. To accommodate the memory usage of the entire network layer, such policies often over-allocate memory space. The study by Rhu et al. mentioned that this memory underutilization problem becomes more serious for deeper networks, with 53% to 79% of the allocated memory not being utilized during training time. In order to solve the memory capacity bottleneck, machine learning practitioners must either use less ideal DNN architectures-lower number of layers, smaller batch sizes, convolutional algorithms with poor performance but higher memory efficiency, or consider multiple Parallel processing of DNN on GPU. These methods will undoubtedly hinder the speed and accuracy of training, thereby reducing the performance of the DNN model.

In response to problems such as the limited memory capacity of GPUs and the communication efficiency between cores being limited by the PCIe bus, many researchers have considered using CPU-GPU heterogeneous computing systems to accelerate the deep learning process. Heterogeneous systems integrate a variety of computing cores and multi-level storage systems on-chip, achieving higher inter-core communication speeds and larger cache and memory space, thereby moderately alleviating the memory access pressure of the DNN model. However, the improvement of heterogeneous multi-core computing efficiency has caused the system to face new memory access restrictions. At the same time, simple expansion of available memory still cannot solve the fundamental problem of low memory utilization during DNN training.

The training process of DNN can be roughly divided into two processes: forward propagation and back propagation. Forward propagation proceeds from the first (input) layer to the last (output) layer, while backward propagation proceeds in the opposite direction. Forward propagation traverses the network layer by layer and performs feature extraction and classification tasks on the given input. During the forward propagation process, each layer performs mathematical operations on its input feature map X and stores the operation results as the output feature map Y. The calculation process of forward propagation is a serialization process. For linear feedforward DNN, the Y obtained by the n−1th layer will be directly used as the input X by the nth layer. Due to this inter-layer data dependency, the GPU can only process the calculations of a single layer at the same time during the training cycle. Therefore, the memory allocation required for each layer is determined by the input-output relationship of the layer and its activation function.

For an incompletely trained DNN model, there is a large error in the results of one round of inference. The calculation process of backpropagation uses a loss function to derive the size of the inference error at the end of forward propagation. The gradient of the loss function is derived relative to the output of the last layer. The backpropagation process uses the loss function as the input gradient map dY of the n-th layer, derives the output gradient map dX according to the chain rule, and passes it to the n−1th layer as the new dY for operation. Since the X and Y values of the current layer need to participate in the calculation during the derivation, it is usually necessary to store all X, Y and dX, dY of this layer. These intermediate data are usually collectively called feature maps, and they occupy more than half of the system storage space in most DNN models, resulting in a large amount of waste of storage resources.

### SUMMARY

In order to solve the problems of low memory utilization and memory access delays that significantly affect computing efficiency caused by the network-wide memory allocation strategy commonly used when running DNN in heterogeneous multi-core computing systems, the present invention proposes a method for offloading and prefetching the last level cache (LLC) space used by the feature extraction layer of DNN, this method is deployed on a heterogeneous multi-core computing system. The invention unloads the feature graph that has completed forward transmission in the forward propagation process but is still residing in the cache space waiting for gradient update into DRAM through the bus, and pre-retriels the data LLC and effectively hides the prefetch delay before calling the data in the back propagation process, so as to improve the hit rate of the last level cache in the training process, reduce memory access latency associated with high-frequency access requests from LLC to DRAM.

In order to achieve the above objects, the present invention adopts the following technical solutions:
Step 1: allocate an area in the memory area when the program starts; the size of this area matches the last-level cache capacity; in actual operation, the size of this area can be adjusted according to the size of the DNN model;
Step 2: during the feature extraction process of each iteration, the algorithm continues to track the feature map additional delay; after the transmission is completed, the algorithm will track the inter-layer dependencies in the form of a data flow graph, evaluate that when the current processing layer is the last consumer of X, release X from the LLC to free up buffer space;
Step 3: at the beginning of the backpropagation process, the algorithm prefetches the data of the previous layer from the memory offload area, overlapping the time of calculation and transmission operations and maximizing the gain of latency hiding; the algorithm tracks the computation flow and the transport flow synchronously so that the computation of the current layer is paused in the event of incomplete prefetching;
Step 4: during the backpropagation process, when the gradient update of each layer has been completed, since the Y and dY of the current layer as intermediate data have completed their contribution to the gradient descent calculation, the algorithm unloads the areas from the LLC and memory at the same time as they were previously data release; the X and dX of the current layer will not be released at this time, because the backpropagation of the previous layer also requires these values for gradient derivation.

Compared with the prior art, the present invention has the following advantages:

Most of the existing DNN memory management technologies focus on improving communication speed and expanding memory capacity. The on-chip network architecture of the CPU-GPU heterogeneous computing system significantly improves the communication speed between cores and between the cores and the memory controller. At the same time, the integrated GPU core can obtain larger cache and memory space than an independent GPU. On this basis, the present invention further optimizes the utilization rate and hit rate of the last-level cache. Due to the large throughput and randomness of data during the DNN training process, the LLC in the traditional storage structure usually maintains a high future rate for a long time. Hit rate. Too many access requests from LLC to DRAM bring relatively long communication delays, requiring frequent calculation stops to wait for data transmission, which reduces training efficiency. The offloading strategy for LLC deployment divides data transmission in a fine-grained manner, overlapping most of the intermediate data access processes and calculation processes in the feature extraction layer, significantly optimizing the memory access efficiency. The prefetch strategy makes the data flow in LLC more effective for the gradient descent calculation process, which can significantly improve the cache hit rate during backpropagation and reduce additional memory access delays.

### DESCRIPTION OF THE DRAWINGS

FIG. 1 is the architecture diagram of CPU-GPU heterogeneous multi-core system;

FIG. 2 is the flow chart of the memory access controller in the linear feedforward neural network;

FIG. 3 is the schematic diagram of the delayed hiding process,

FIG. 4 is the data flow diagram of a nonlinear feedforward neural network.

### PREFERRED EMBODIMENT

In order to make the purpose, technical solutions and advantages of the present invention more clear, the embodiments of the present invention will be described in detail below with reference to the accompanying drawings.

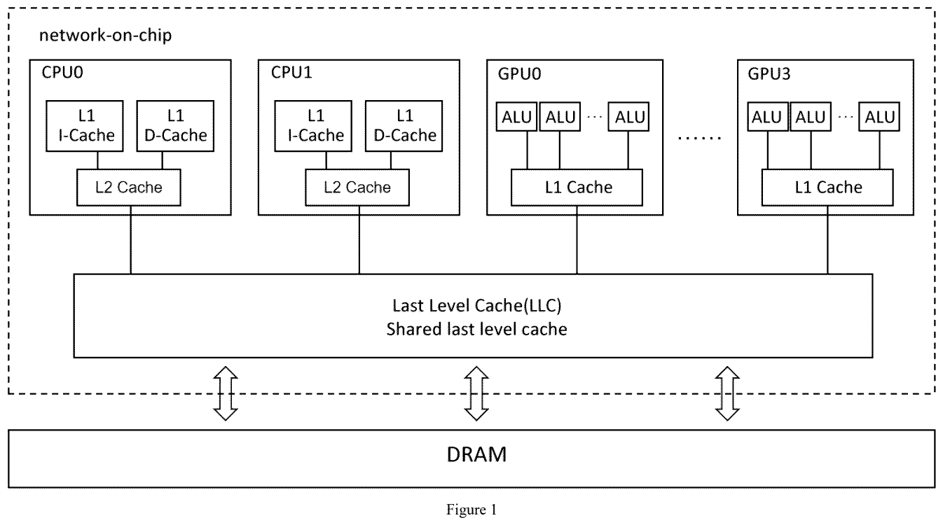

The invention relates to a storage structure for a cache unloading and prefetch method deployed for the training process of a deep neural network model based on heterogeneous multi-core system, as shown in FIG. 1. The heterogeneous multi-core system consists of 2 CPU cores and 4 GPU cores to form the heterogeneous multi-core architecture, each CPU core contains a private L1-level data cache and instruction cache and L2 level cache, each GPU contains a private L1-level cache shared by all ALU (arithmetic logic unit), and all CPU cores share final-level shared cache (LLC) and main memory controller DRAM with GPU cores, all communication between cores is carried out by the on-chip network NOC.

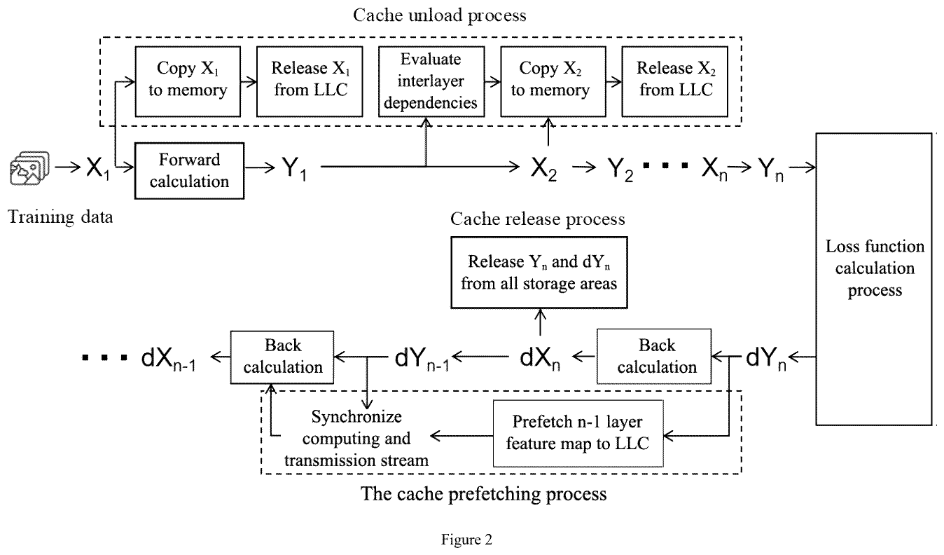

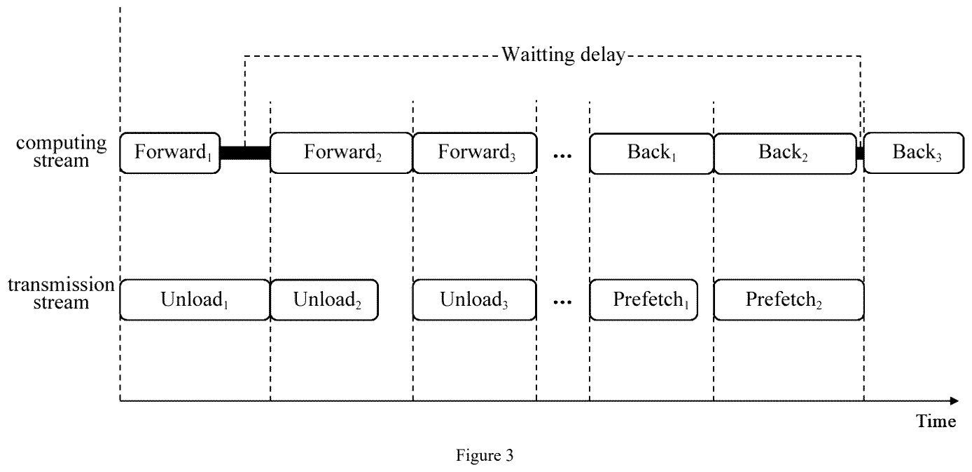

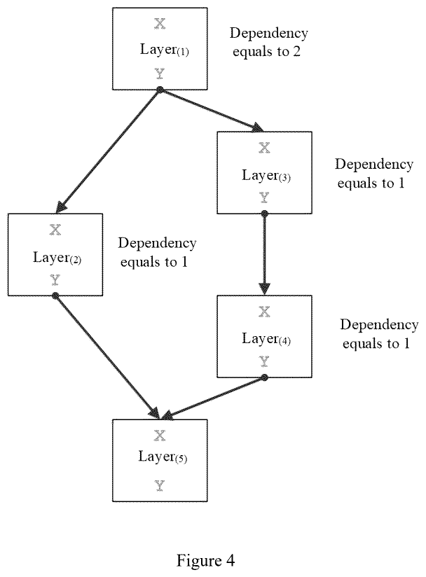

The process in the linear feedforward neural network is as shown in FIG. 2. X/Y in the figure respectively represent the input/output feature map of each layer of forward propagation, and dX/dY respectively represent the output/input feature gradient map of each layer of back propagation. This method adds memory access controller logic to each feature extraction layer of DNN training, including cache unloading process in forward propagation, cache prefetch process and memory release process in back propagation, and priority-based random cache replacement strategy, so that DNN can make more efficient use of the space of the last level shared cache when training on heterogeneous multi-core systems. Reduce the computing performance loss caused by waiting too much for DRAM memory access response. The specific steps are as follows:
Step 1: When loading the training data set, allocate an offload area of equal space in DRAM based on the shared LLC capacity in the system. Whenever the memory access controller allocates and releases a data structure during DNN training, the memory manager will allocate and release a memory area from this area.
Step 2: When the data preprocessing ends and the forward propagation process begins, the memory access controller monitors the feature map data transmission and calculation process of each layer, and copies the input feature map X to memory offloading area (during the training process of DNN, the output feature diagram Yn of layer n, the input gradient diagram dYn are equivalent to the input feature diagram Xn+1 of layer n+1, the output gradient diagram dXn+1, so Y and dY do not require extra storage space). Parallel computing flows and transmission flows in the delay hiding process such as shown in FIG. 2, the figure depicts the performance of three layers with different calculation time-transmission time ratios in the delay hiding mechanism. When there is a situation where the offloading time exceeds the calculation time, since the forward calculation process occupies the transmission stream resources, the calculation of the next layer needs to be suspended to wait for the data to be safely offloaded. However, even if there may be a waiting delay, most of the transmission time is still overlapped in the calculation process, which effectively reduces the additional transmission cost caused by the offloading mechanism. When the unloading process is completed, the memory access controller releases the space of X from the LLC.
Step 3: Before the subsequent forward propagation of each layer starts, the memory access controller first evaluates the data dependencies between layers based on the data flow graph. When the DNN model is a feedforward linear network (such as AlexNet), the output feature map Y of the previous layer forms a unique dependency relationship with the input feature map X of this layer, and the unloading/release process can be performed directly without additional conditions. However, when the DNN model uses a nonlinear feedforward network such as GoogleNet, the situation as shown in FIG. 4 will appear, the output Y of the first layer in the network will be passed to the second and third layers for calculation. At this time, the memory access controller will pre-construct the data flow graph of the model and calculate the number of dependencies of each layer's output feature map Y. Since layers that depend on the same Y share X data, in order to maximize cache utilization, only the current processing layer must be determined. The uninstallation/release process can only be allowed when it is the last dependency layer of its predecessor output feature map Y.
Step 4. After the backpropagation process starts, the memory access controller prefetches the X value required by the previous layer back into the LLC when performing the reverse calculation process on the input gradient map dY of each layer, and performs the delay hiding process in parallel. The calculation flow and transmission flow are shown in FIG. 3. Similar to the offloading process, when there is a situation where the prefetch transmission time exceeds the calculation time, the memory access controller pauses the calculation process of the previous layer to wait for data safety prefetching. Since the backpropagation process requires X and Y of each layer to participate in the calculation, the prefetching of X in this step will not fully cover the memory access request of the calculation process after layer 2. In order to prevent data transmission during the reverse calculation process from washing out the data prefetched into the LLC, the present invention adopts a random cache replacement strategy based on marking priority, and adds a bit register to each cache block in the LLC to mark the priority. When the memory access controller prefetches X, the cache block mark bit is assigned a value of 1. Since the reuse rate of intermediate data in the DNN training process is very low, during the cache replacement process, a cache block is randomly selected from the buffer and the mark bit is determined. If the prefetched data marked as 1 is selected, the random selection process is repeated. Otherwise, replace directly at this location. This mark replacement strategy can ensure the security of prefetched feature map data while minimizing the computation time.
Step 5: After the gradient update process of each layer is completed, release the space in the cache and DRAM offload area occupied by Y and dY of the current layer (i.e., X and dX of the previous layer).

1. A memory access management method for heterogeneous multi-core systems based on deep neural networks is characterized in that:
the method unloads the feature graph that has completed forward transmission in the forward propagation process but is still residing in the cache space waiting for gradient update into DRAM through the bus, and pre-retriels the data LLC and effectively hides the prefetch delay before calling the data in the back propagation process, so as to improve the hit rate of the last level cache in the training process, reduce memory access latency associated with high-frequency access requests from LLC to DRAM; the method comprises the following steps:
Step 1: allocate an area in the memory area when the program starts; the size of this area matches the last-level cache capacity; in actual operation, the size of this area can be adjusted according to the size of the DNN model;
step 2: when the data preprocessing ends and the forward propagation process begins, the memory access controller monitors the feature map data transmission and calculation process of each layer, and copies the input feature map X to memory offloading area; during the training process of DNN, the output feature diagram Yn of layer n, the input gradient diagram dYn are equivalent to the input feature diagram Xn+1 of layer n+1, the output gradient diagram dXn+1, so Y and dY do not require extra storage space; when there is a situation where the offloading time exceeds the calculation time, since the forward calculation process occupies the transmission stream resources, the calculation of the next layer needs to be suspended to wait for the data to be safely offloaded; when the unloading process is completed, the memory access controller releases the space of X from the LLC;
step 3: before the subsequent forward propagation of each layer starts, the memory access controller first evaluates the data dependencies between layers based on the data flow graph. When the DNN model is a feedforward linear network, the output feature map Y of the previous layer forms a unique dependency relationship with the input feature map X of this layer, and the unloading/release process can be performed directly without additional conditions; when the DNN model uses a nonlinear feedforward network such as GoogleNet, the memory access controller will pre-construct the data flow graph of the model and calculate the number of dependencies of each layer's output feature map Y. Since layers that depend on the same Y share X data, in order to maximize cache utilization, only the current processing layer must be determined; the uninstallation/release process can only be allowed when it is the last dependency layer of its predecessor output feature map Y;
Step 4. after the backpropagation process starts, the memory access controller prefetches the X value required by the previous layer back into the LLC when performing the reverse calculation process on the input gradient map dY of each layer; similar to the offloading process, when there is a situation where the prefetch transmission time exceeds the calculation time, the memory access controller pauses the calculation process of the previous layer to wait for data safety prefetching; since the backpropagation process requires X and Y of each layer to participate in the calculation, the prefetching of X in this step will not fully cover the memory access request of the calculation process after layer 2; in order to prevent data transmission during the reverse calculation process from washing out the data prefetched into the LLC, adopts a random cache replacement strategy based on marking priority, and adds a bit register to each cache block in the LLC to mark the priority; when the memory access controller prefetches X, the cache block mark bit is assigned a value of 1; since the reuse rate of intermediate data in the DNN training process is very low, during the cache replacement process, a cache block is randomly selected from the buffer and the mark bit is determined; if the prefetched data marked as 1 is selected, the random selection process is repeated; otherwise, replace directly at this location;
Step 5: After the gradient update process of each layer is completed, release the space in the cache and DRAM offload area occupied by Y and dY of the current layer.
